(19) United States
(12) Patent Application Publication
(10) Pub. No.: US 2017/0353877 A1
(43) Pub. Date: Dec. 7, 2017

(54) WIRELESS COMMUNICATION METHODS AND APPARATUS

(71) Applicant: KABUSHIKI KAISHA TOSHIBA, TOKYO (JP)

(72) Inventors: Parag Gopal KULKARNI, Bristol (GB); Fengming CAO, Bristo (GB)

(73) Assignee: KABUSHIKI KAISHA TOSHIBA, TOKYO (JP)

(21) Appl. No.: 15/506,069

(22) PCT Filed: Feb. 9, 2015
(86) PCT No.: PCT/GB2015/050342

§ 371 Date: Feb. 23, 2017

(51) Int. Cl. H04W 24/08; H04W 72/08; H04W 88/08

(52) U.S. Cl. CPC H04W 24/08; H04W 72/085; H04W 88/08

(57) ABSTRACT

In an embodiment, a wireless communication method in an access point of a wireless network is disclosed. The access point comprises at least one wireless interface operable to communicate on one of a plurality of channels. The method comprises monitoring each of the plurality of channels, wherein monitoring a monitored channel from the plurality of channels comprises switching the wireless interface to the monitored channel; receiving a plurality of indications, each transmitted by a second access point on the monitored channel and indicating an aggregate traffic level calculated by the respective second access point; and storing an indication of the highest aggregate traffic level received for the monitored channel; comparing the stored highest aggregate traffic levels for the plurality of channels; selecting as a communication channel, the channel from the plurality of channels having the smallest stored highest aggregate traffic level; and communicating over the communication channel.

### FIELD

Embodiments described herein relate generally to wireless communication methods and apparatus and more specifically to facilitating channel allocation by access points in a wireless network.

### BACKGROUND

Wireless Local Area Networks (WLAN or Wi-Fi) are used by smartphones and mobile computing devices. The growing popularity and proliferation of such devices has led to wireless local area networks becoming more and more congested. It is expected that future Wi-Fi deployments will be highly dense, featuring heavy traffic load and overlapping basic service sets (OBSS). It is expected that the proximity between neighbouring access points (APs) will continue to shrink. Such developments are likely to lead to a significant increase in inter-cell or inter-AP interference, which may degrade the system performance to unacceptable levels.

To address the heavy load and OBSS issues, channel allocation is a key technique, where the available channels are allocated to avoid or mitigate the interference. Depending on the network deployment, there are two possible scenarios: centralized control and uncoordinated/unplanned deployments. The first assumes cooperation among the APs. However, the majority of APs actually operate under the latter regime wherein each AP is running independently and belong to different administrative entities.

### BRIEF DESCRIPTION OF THE DRAWINGS

In the following, embodiments will be described with reference to the drawings in which:

FIG. 1 shows a wireless network according to an embodiment;

FIG. 2 shows an access point according to an embodiment;

FIG. 3 shows a wireless network environment according to an embodiment;

FIG. 4 shows a method of wireless communication according to an embodiment;

FIG. 5 shows the information included in a beacon frame transmitted by an access point according to an embodiment;

FIGS. 6a and 6b show a method of communication including selecting a communication channel using the aggregate traffic information from a beacon frame according to an embodiment;

FIG. 7 shows a method of wireless communication according to an embodiment;

FIG. 8 shows the process in an embodiment of resetting a value used during normal operation to track the state of the channel on which the AP is operating;

FIG. 9 shows a method of transmitting a beacon frame according to an embodiment;

FIG. 10 shows a channel selection method during an access point start up procedure according to an embodiment;

FIG. 11 shows a method of updating channel traffic information according to an embodiment;

FIG. 12 shows a method of switching communication channel in an embodiment; and

FIGS. 13 to 15 show an example of a network environment and the information gathered by an access point according to an embodiment.

### DETAILED DESCRIPTION

In an embodiment, a wireless communication method in an access point of a wireless network is disclosed. The access point comprises at least one wireless interface operable to communicate on one of a plurality of channels. The method comprises monitoring each of the plurality of channels, wherein monitoring a monitored channel from the plurality of channels comprises switching the wireless interface to the monitored channel; receiving a plurality of indications, each transmitted by a second access point on the monitored channel and indicating an aggregate traffic level calculated by the respective second access point; and storing an indication of the highest aggregate traffic level received for the monitored channel; comparing the stored highest aggregate traffic levels for the plurality of channels; selecting as a communication channel, the channel from the plurality of channels having the smallest stored highest aggregate traffic level; and communicating over the communication channel.

In an embodiment, receiving a plurality indications comprises receiving a plurality of beacon frames and extracting an indication of an aggregate traffic level from each of the beacon frames.

In an embodiment, a wireless communication method in an access point of a wireless network is disclosed. The method comprises receiving indications from other access points over a communication channel of the wireless network, the received indications each indicating a traffic level on the communication channel of a respective other access point; calculating an aggregate traffic level from the received indications; and transmitting an indication of the aggregate traffic level on the communication channel.

In an embodiment, ransmitting an indication of the aggregate traffic level on the communication channel comprises transmitting a beacon frame on the communication channel, the beacon frame comprising the indication of the aggregate traffic level.

In an embodiment, the beacon frame further comprises an indication of the traffic level on the communication channel of the access point.

In an embodiment, calculating the aggregate traffic level from the received indications comprises calculating the sum of the traffic levels on each of the other access points.

In an embodiment an access point for a wireless network is disclosed. The access point comprises a wireless network interface configured to receive indications on a communication channel from other access points, the received indications each indicating a traffic level on the communication channel of a respective other access point; and a calculation module configured to calculate an aggregate traffic level from the received indications. The wireless network interface is further configured to transmit an indication of the aggregate traffic level on the communication channel.

In an embodiment, the wireless network interface is configured to transmit a beacon frame on the communication channel, the beacon frame comprising the indication of the aggregate traffic level.

In an embodiment, the beacon frame further comprises an indication of the traffic level on the communication channel of the access point.

In an embodiment, the wireless network interface is configured to receive beacon frames transmitted by the other access points and the access point further comprises a monitoring module configured to extract the received indications from the beacon frames.

In an embodiment, an access point for a wireless network is disclosed. The access point comprises a wireless interface operable to communicate on one of a plurality of channels, a channel selection module configured to control the wireless network interface to receive signals on a monitored channel from the plurality of channels; a monitoring module configured to monitor the monitored channel and extract indications, each transmitted by other access points on the monitored channel and indicating an aggregate traffic level calculated by the respective other access point; a memory configured to store the highest aggregate traffic level received for each of a plurality of monitored channels; and a calculation module configured to compare the stored highest aggregate traffic levels for the plurality of monitored channels, wherein the channel selection module is configured to select as a communication channel, the channel from the plurality of channels having the smallest stored highest aggregate traffic level.

In an embodiment, the access point further comprises a communication module configured to control the wireless network interface to communicate on the communication channel.

In an embodiment, the access point further comprises a second wireless network interface and a communication module configured to control the second wireless network interface to communicate on the communication channel.

In an embodiment, the monitoring module is configured to extracting an indication of an aggregate traffic level from beacon frames transmitted by the respective other access points.

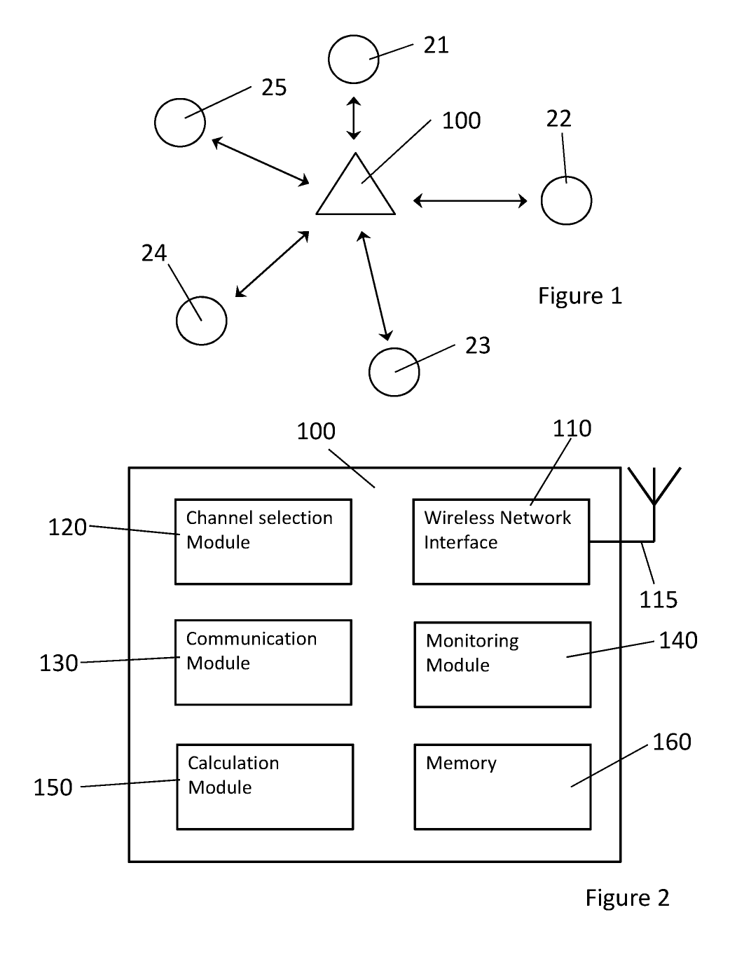

FIG. 1 shows a wireless network according to an embodiment. The wireless network comprises the access point (AP) 100, and five clients (STAs) 21, 22, 23, 24, 25. The clients communicate wirelessly with the access point 100 over a wireless channel.

FIG. 2 shows the access point 100 in further detail. The access point 100 comprises a wireless network interface 110, a channel selection module 120, a communication module 130, a monitoring module 140, a calculation module 150 and a memory 160. The wireless network interface 110 is coupled to an antenna 115.

The wireless network interface 110 is operable to send and receive signals using the antenna 115 on one or more of a plurality of radio frequency channels defined in a radiofrequency spectrum. The channel selection module 120 selects which of the radio frequency channels the wireless network interface 110 uses. The communication module 130 controls the wireless network interface 110 to send and receive signals according to a communication protocol, for example, to client STAs as described above in relation to FIG. 1. The monitoring module 140 monitors the signals received by the wireless network interface 110 and detects beacon frames transmitted by other access points (APs) operating on the same channel as the wireless network interface 110. The calculation module 150 performs calculations on the data extracted by the monitoring module 140 from beacon frames transmitted by other APs. The memory 160 stores data extracted from the beacon frames transmitted by other APs.

The methods carried out by the modules of the AP 100 are described in more detail below.

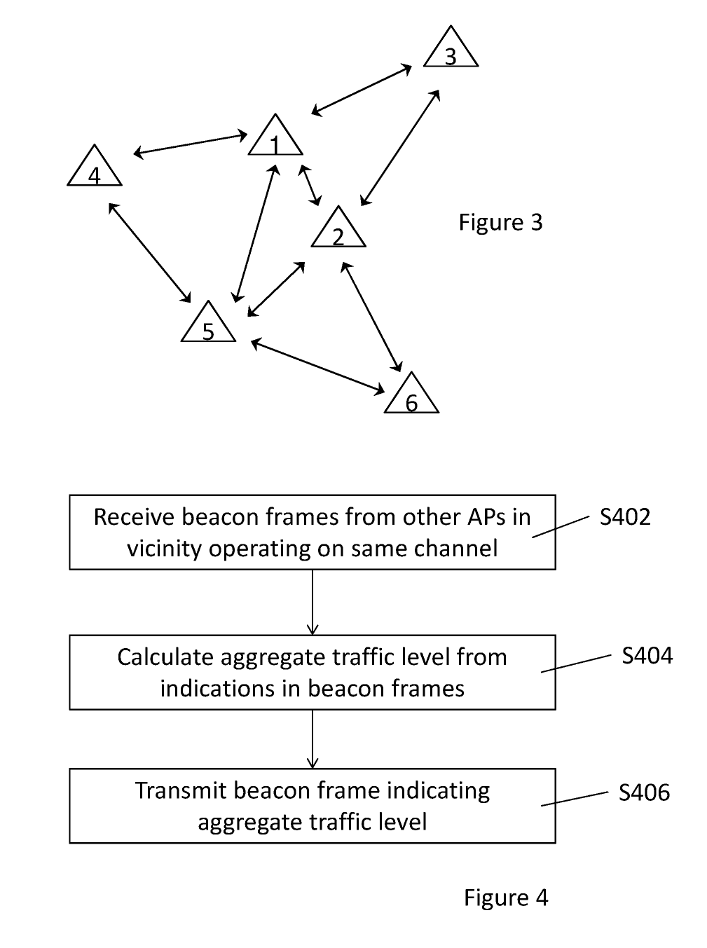

FIG. 3 shows a wireless network environment according to an embodiment. The wireless network environment comprises a first access point (AP) 1, a second AP 2, a third AP 3, a fourth AP 4, a fifth AP 5, and a sixth AP 6. In the following description it is assumed that the APs are all operating on the same frequency channel and that each AP has an associated set of wireless clients. The arrows shown in FIG. 3 indicate that an AP can receive beacon frames transmitted by another AP. When an AP can receive beacon frames transmitted by another AP, this is an indication that transmissions by the other AP are likely to cause interference. As shown in FIG. 3, the first AP 1 can receive beacon frames transmitted by the second AP 2, the third AP 3, the fourth AP 4, and the fifth AP 5. The second AP 2 can receive beacon frames transmitted by the first AP 1, the third AP 3, the fifth AP 5, and the sixth AP 6. The third AP 3 can receive beacon frames transmitted by the first AP 1 and the second AP 2. The fourth AP 4 can receive beacon frames transmitted by the first AP 1 and the fifth AP 5. The fifth AP can receive beacon frames transmitted by the first AP 1, the second AP 2, the fourth AP 4, and the sixth AP 6. The sixth AP 6 can receive beacon frames transmitted by the second AP 2, and the fifth AP 5.

Embodiments of the present invention allow APs to select a channel which minimises or reduces the interference from other APs operating in its vicinity. This is achieved by including traffic information in beacon frames transmitted by the APs. Each AP broadcasts its traffic state via the beacon frame. The traffic state may be a function of the level of traffic that the AP has been handling over a window of time. When an AP receives beacons from other APs in the vicinity operating on the same channel, it extracts traffic state information of those other APs and stores the extracted traffic state information in a table and then discards these beacon frames. By computing an aggregate function on these traffic state values the AP can determine the potential interference from these neighbouring cells. Therefore, in addition to advertising its own traffic state, it will also advertise this aggregate value via the beacon frame.

FIG. 4 shows a method of wireless communication according to an embodiment. The method is carried out by an AP as shown in FIG. 2.

In step S402, the wireless network interface 110 of the AP 100 receives beacon frames from other APs in the vicinity operating on the same channel, in the following this channel is referred to as the operating channel. In the example shown in FIG. 3, the first AP 1 will receive beacon frames from the second AP 2, the third AP 3, the fourth AP 4 and the fifth AP 5. The beacon frames received from the APs operating in the vicinity of the AP include indications of the traffic levels on those APs. The traffic level may be the number of packets/bytes transmitted and received over a given window of time. The monitoring module 140 identifies beacon frame originating from other APs and extracts the indications of traffic levels on those APs from the beacon frames.

In step S404, the calculation module 150 of the AP 100 calculates an aggregate traffic level from the individual traffic levels included in beacon frames received on the operating channel. The aggregate traffic level may be calculated by summing the traffic levels received from each of the other APs in the vicinity.

The aggregate traffic level may be the sum of the traffic levels reported by each of the neighbouring APs. The aggregate traffic level may also include the traffic level on the AP itself.

In step S406, the AP 100 transmits a beacon frame including an indication of the aggregate traffic level calculated in step S404. The beacon frame also includes an indication of the traffic level on the AP 100.

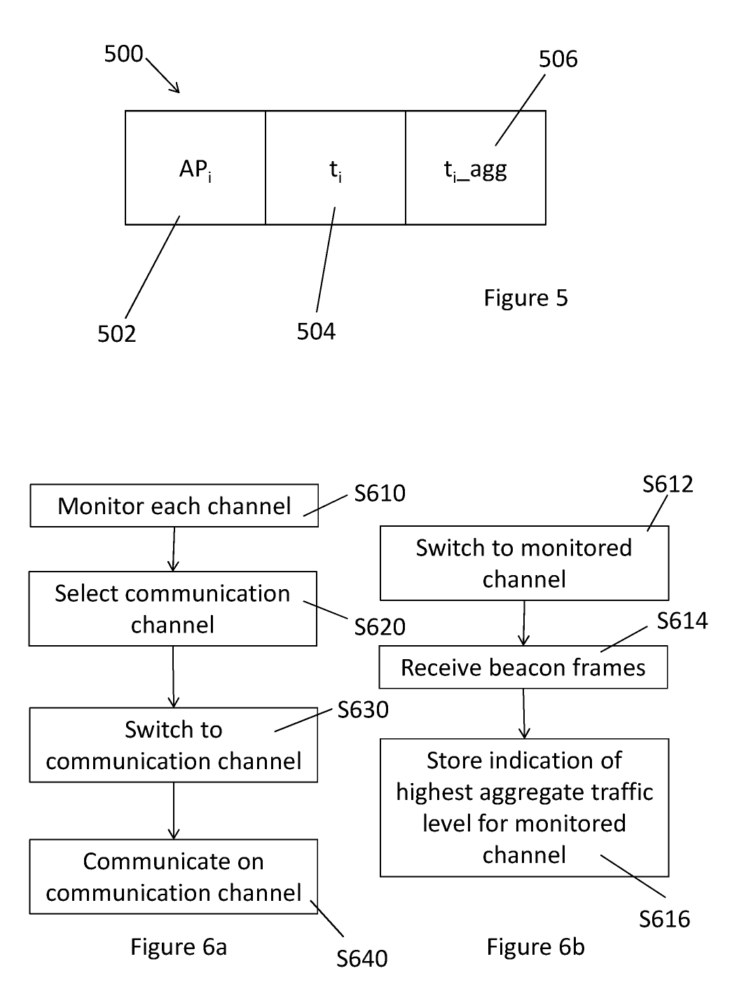

FIG. 5 shows the information included in a beacon frame transmitted by an access point according to an embodiment. The beacon frame 500 includes an identifier 502 of the access point APᵢ, an indication 504 of the traffic level tᵢ on the access point APᵢ, an indication 506 of the aggregate traffic level t_{i—}agg determined for other APs operating on the same channel. The beacon frame may be transmitted by the AP at intervals of 100 to 500 ms.

FIGS. 6a and 6b show a method of communication including selecting a communication channel using the aggregate traffic information from a beacon frame according to an embodiment.

In step S610, the monitoring module 140 monitors each channel in turn. FIG. 6b shows the process of monitoring a monitored channel, which is carried out for each channel in turn. In step S612, the channel selection module 120 causes the wireless network interface 110 to switch to the monitored channel. In step S614, beacon frames from other APs in the vicinity which are transmitting on the monitored channel are received. Indications of the aggregate traffic level calculated by each of the APs in the vicinity which are transmitting on the monitored channel are extracted from the received beacon frames. In step S616, an indication of the highest aggregate traffic level from those extracted is stored in the memory 160 of the AP.

Once all of the channels have been monitored, an indication of the highest aggregate traffic level for each channel is stored in the memory 160 of the AP. The method then moves to step S620. In step S620, the channel having the lowest value for the highest aggregate traffic level is selected as a communication channel.

In step S630, the channel selection module 120 switches the wireless network interface 110 to the communication channel.

In step S640, the AP communicates with its clients using the communication channel.

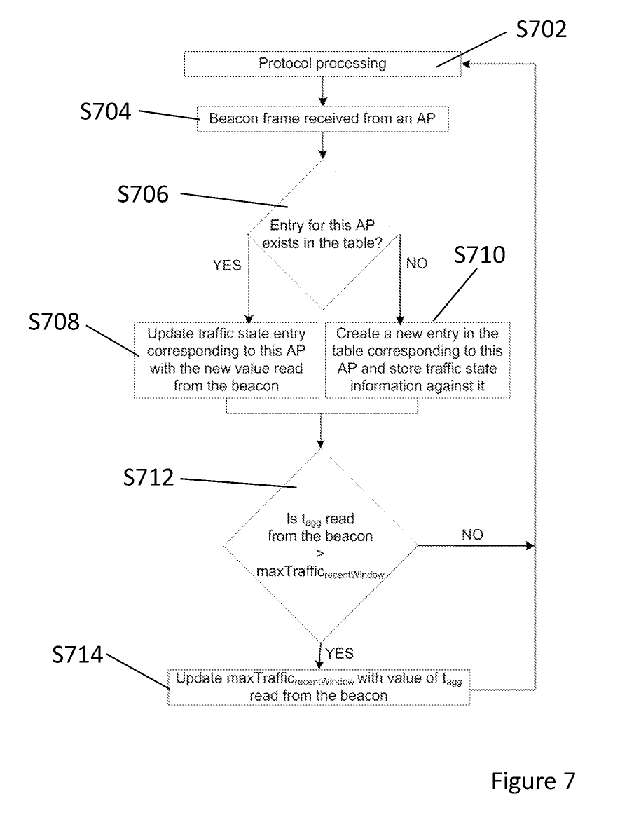

FIG. 7 shows a wireless communication method according to an embodiment. In step S702, protocol processing takes place by the AP communicating on a selected communication channel. This is carried out by the communication module 130 of the AP 100. Signals are sent to and received from clients of the AP. In step S704, a beacon frame transmitted by another AP is received. The monitoring module 140 extracts an identifier of the AP that transmitted the beacon frame, and indications of the traffic state of that AP and the aggregate traffic calculated by that AP.

In step S706, it is determined whether an entry exists in a table stored in the memory 160 for the AP from which the beacon frame originated. If an entry for the AP does exist, the method moves to step S708 in which the traffic state entry in the table is updated with the new value read from the beacon. If an entry does not exist for the AP, the method moves to step S710 in which a new entry is created for the AP and the traffic state information is recorded against the new entry.

Following steps S708 and S710, the method moves to step S712. In step S712, the aggregate value traffic level value t_{agg} read from the beacon is compared with a value maxTraffic_{RecentWindow} which is stored in the memory 160 of the AP. The value maxTraffic_{RecentWindow} is a statistic maintained over a fixed window of time. It is set to 0 at the beginning of each window.

During normal course of operation when AP has already chosen its operating channel and is serving clients, the AP may receive beacons from neighbouring APs operating on the same channel as itself. It will then compare the t_{agg} reported by these APs with the maxTraffic_{RecentWindow}. If higher, it updates the maxTraffic_{RecentWindow} by assigning it this t_{agg} value. This additional window based measurement is mainly to track the state of the operating channel in real time on a short time scale.

If the value of t_{agg} read from the beacon is not greater than the value maxTraffic_{RecentWindow}, the method returns to step S702 in which protocol processing takes place. If the value of t_{agg} read from the beacon is greater than the value maxTraffic_{RecentWindow}, the method moves to step S714. In step S714, the value of maxTraffic_{RecentWindow} is updated with the value of t_{agg} read from the beacon. Following step S714, the method returns to step S702 in which protocol processing takes place.

The value maxTraffic_{RecentWindow} is used during normal operation to track the state of the channel that the AP is operating on.

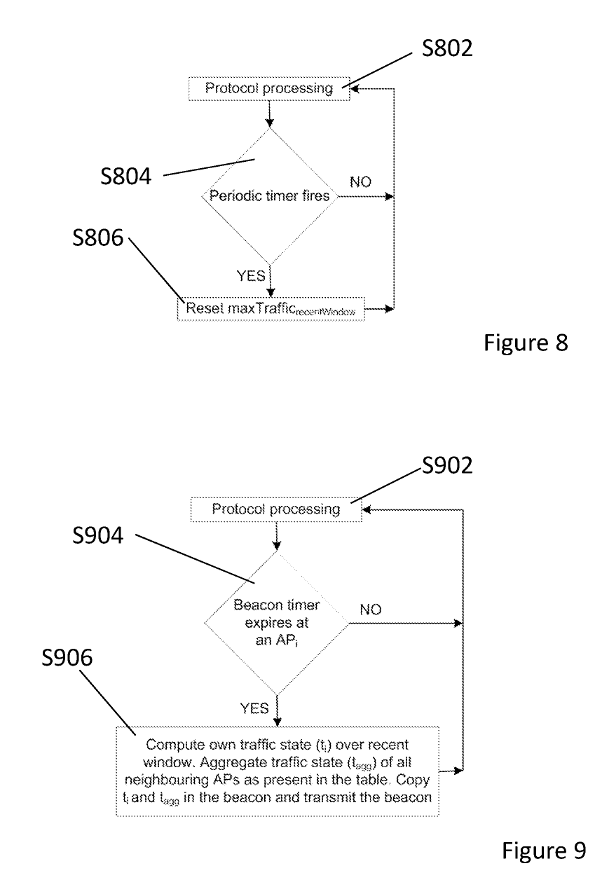

FIG. 8 shows the process in an embodiment of resetting the value maxTraffic_{RecentWindow} used during normal operation to track the state of the channel on which the AP is operating.

In step S802, protocol processing takes place. In step S804, the AP determines whether a periodic timer has fired. The periodic timer sets the length of the window for which the value of maxTraffic_{RecentWindow} is stored. If the periodic timer has not fired, the method returns to step S802 in which protocol processing takes place. If the periodic timer has fired the method moves to step S806. In step S806, the value of maxTraffic_{RecentWindow} is reset, and the method returns to step S802.

FIG. 9 shows a method of transmitting a beacon frame according to an embodiment. In step S902, protocol processing takes place. In step S904, it is determined whether a beacon timer has expired. The beacon timer sets the interval between beacons transmitted by an AP. In an embodiment the beacon timer sets the interval between beacons to a time in the range 100 ms to 500 ms. If the beacon timer has not expired, the method returns to step S902.

If the beacon timer has expired, the method moves to step S904. In step S904, the calculation module 150 calculates the traffic state tᵢ for the AP over the recent time window. The calculation module also calculates the aggregate traffic state t_{agg} of all neighbouring APs using the table stored in the memory 160. The calculated values of the traffic state tᵢ and the aggregate traffic state t_{agg} of all neighbouring APs are inserted into a beacon with an identifier of the AP as shown in FIG. 5. Then the beacon is transmitted. Following step S904, the method returns to step S902.

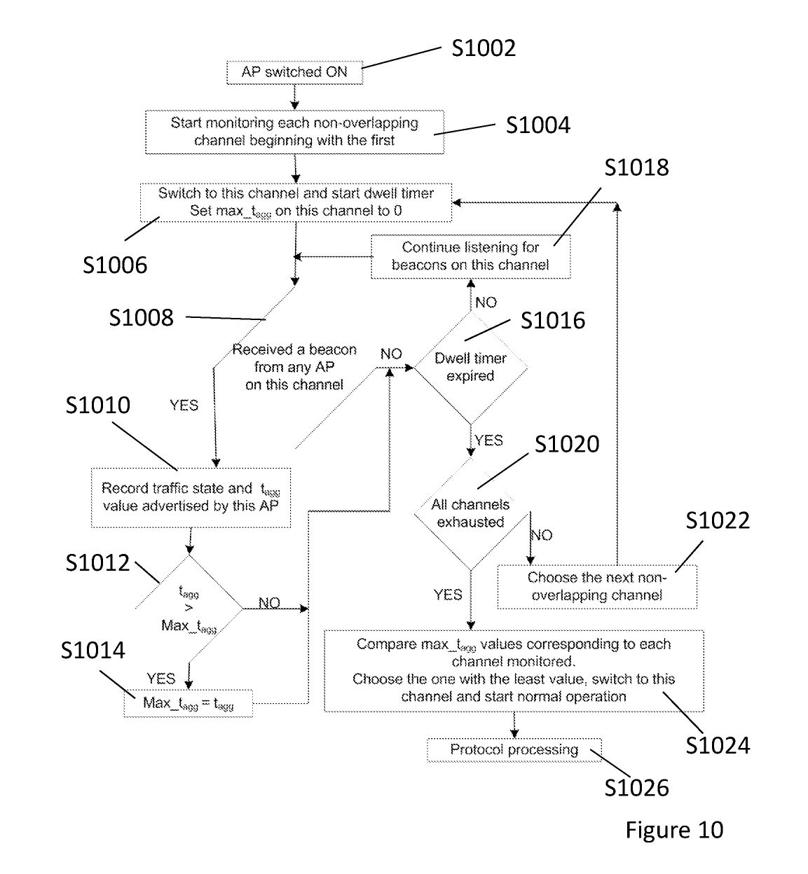

FIG. 10 shows a channel selection method during an access point start up procedure according to an embodiment.

In step S1002, the AP is switched on. When the AP powers on, it tunes to the first non-overlapping channel in step S1004. The AP dwells on this channel for a fixed period of time, gathers information on this channel and moves onto the next when the dwell timer expires. In step S1006, the AP switches to the channel to be monitored, starts the dwell timer and sets the value of max_t_{agg} for the monitored channel to zero.

In step S1008 the AP listens for beacon frames to capture the state of the neighbourhood on the monitored channel. The AP determines whether a beacon has been received from any AP on the monitored channel. If a beacon has been received on the monitored channel, the method moves to step S1010. In step S1010, the traffic state and aggregate traffic value t_{agg} from the beacon are recorded in the memory of the AP. In step S1012, the aggregate traffic value t_{agg} from the beacon is compared with the stored maximum aggregate traffic value observed for the monitored channel. If the aggregate traffic value from the beacon is greater than the stored maximum aggregate traffic value observed for the monitored channel then the method moves to step S1014 in which the stored maximum aggregate traffic value observed for the monitored channel is updated with the aggregate traffic value from the beacon. The method then moves to step S1016. If the aggregate traffic value from the beacon is not greater than the stored maximum aggregate traffic value observed for the monitored channel then the method moves to step S1016 without updating the stored maximum aggregate traffic value observed for the monitored channel.

If in step S1008, no beacon is received, the method moves to step S1016. In step S1016, the AP determines whether the dwell timer has expired. If the dwell timer has not expired, the method moves to step S1018 in which the AP continues to listen for beacons on the monitored channel, and the method continues to step S1008 as described above.

If in step S1016, the AP determines that the dwell timer has expired, the method moves to step S1020. The AP will maintain statistics for each non-overlapping channel over a certain window. The length of the window may be equal to the dwell time on the channel or longer. Upon expiration of the dwell time counter, the AP will move to the next channel and repeat the above process. This process will continue until the AP completes scanning all the non-overlapping channels.

In step S1020, the AP determines whether all channels have been monitored. If there are still remaining channels to be monitored, the method moves to step S1022. In step S1022, the next channel is selected as the monitored channel and the method returns to step S1006 in which monitoring of the new monitored channel starts. If in step S1020, it is determined that all channels have been monitored, the method moves to step S1024.

In step S1024, the maximum aggregate traffic values for each of the channels are compared. The channel having the lowest maximum aggregate traffic value is selected as the communication channel for the AP. The AP then switches to the communication channel and normal operation starts. In step S1026, protocol processing takes place with the communication channel used for communication.

Embodiments are envisaged for use in dense OBSS environments. Therefore, there is a high likelihood of finding traffic on each channel and therefore for whatever short period of time an AP dwells on a channel that is being monitored, it will record some activity and therefore be able to gather some statistics on its potential neighbourhood on the channel being monitored.

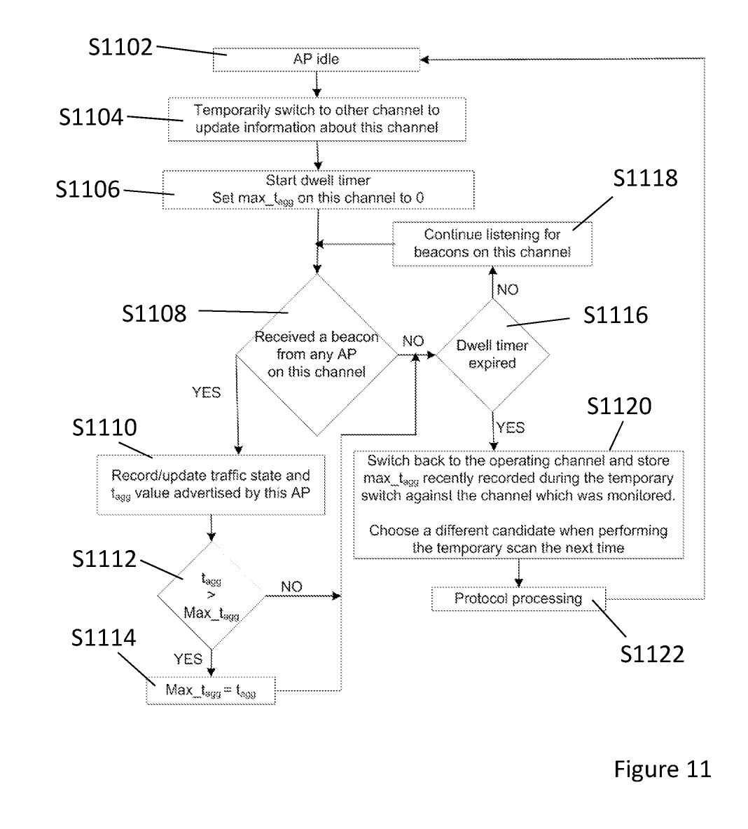

Assuming that an AP has a single radio card or wireless network interface, it will, every either periodically or when it is idle, temporarily listen to other channels to keep potential interference information on these up to date. This process is described below with reference to FIG. 11.

FIG. 11 shows a method of updating channel traffic information according to an embodiment.

In step S1102, the AP determines that it is idle and starts the channel traffic information update process. In step S1104, the AP switches to a channel to be monitored to update information on the monitored channel. In step S1106, the AP switches to the channel to be monitored, starts the dwell timer and sets the value of max_t_{agg} for the monitored channel to zero.

The method then moves to step S1108 in which the AP listens for beacons on the monitored channel. When a beacon is received on the monitored channel the method moves to step S1110. When no beacon is received, the method moves to step S1116.

In step S1110, the traffic state and aggregate traffic value t_{agg} from the beacon are recorded in the memory of the AP. In step S1112, the aggregate traffic value t_{agg} from the beacon is compared with the stored maximum aggregate traffic value observed for the monitored channel. If the aggregate traffic value from the beacon is greater than the stored maximum aggregate traffic value observed for the monitored channel then the method moves to step S1114 in which the stored maximum aggregate traffic value observed for the monitored channel is updated with the aggregate traffic value from the beacon. The method then moves to step S1116. If the aggregate traffic value from the beacon is not greater than the stored maximum aggregate traffic value observed for the monitored channel then the method moves to step S1116 without updating the stored maximum aggregate traffic value observed for the monitored channel.

In step S1116, the AP determines if the dwell timer has expired. If the dwell timer has not expired, the method moves to step S1118 and the AP continues to listen for beacons on the monitored channel, and the method returns to step S1108. If the dwell timer has expired, the method moves to step S1120.

In step S1120, the AP switches back to the operating channel and stores the recorded maximum aggregate traffic value observed for the monitored channel in the memory. The next time a temporary scan is performed, a different channel is chosen as the monitored channel. The method moves to step S1122 in which protocol processing takes place.

As described above, when any new statistics are gathered, previously held records will be updated. In embodiments, an AP may adopt a more reactive approach, e.g., monitor only when it experiences bad performance to identify if better alternatives are available.

The AP may switch its operating communication channel under different circumstances. For example, a switch of communication channel may take when a scan of neighbouring channels indicates availability of promising alternatives compared to the operating channel. Alternatively a switch of channel may be triggered when the level of interference it is experiencing goes up in comparison to what it was when the operating channel was chosen, this could be detected by the retransmission rate going up. Since each AP is dynamically monitoring and maintaining up to date information on different channels, at any given point in time, it can choose the one that promises to offer the best performance.

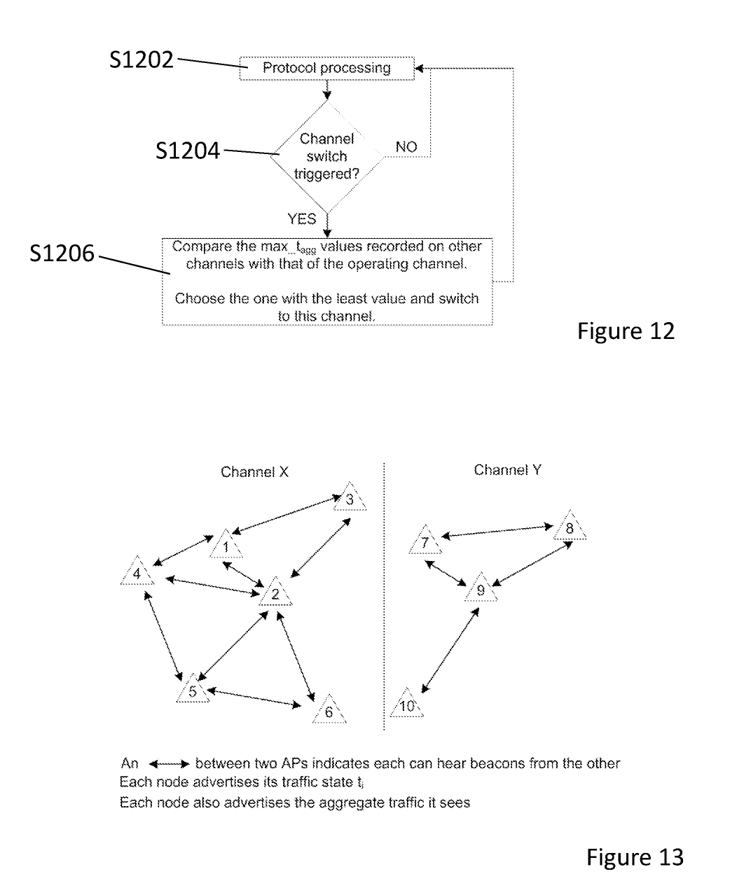

FIG. 12 shows a method of switching communication channel in an embodiment. In step S1202 protocol processing takes place. In step S1204, it is determined whether a channel switch has been triggered. Possible channel switch triggers are discussed in the paragraph above. In step S1206 the AP compares the maximum aggregate traffic values recorded on other channels with that for the current communication channel. The channel having the lowest maximum aggregate traffic value is selected as the new communication channel and the AP switches to this channel.

Since each node makes decisions independently in a distributed manner, there is no need for a centralised controller. In embodiments, when operating in a dense environment, whilst it may be likely that all of the channels are busy, the AP will resort to choosing the path of least resistance.

FIGS. 13 to 15 show an example of a network environment and the information gathered by an access point according to an embodiment.

FIG. 13 shows 10 access points in the network environment. A first access point 1, a second access point 2, a third access point 3, a fourth access point 4, a fifth access point 5, and a sixth access point 6 operate on a first channel, channel X. The arrows between access points in FIG. 13 indicate where access points can receive beacons from one another. A seventh access point 7, an eighth access point 8, a ninth access point 9 and a tenth access point 10 operate on a second channel, channel Y. Each of the access points advertises its own traffic state tᵢ and also the aggregate traffic state that it observes on its operating channel.

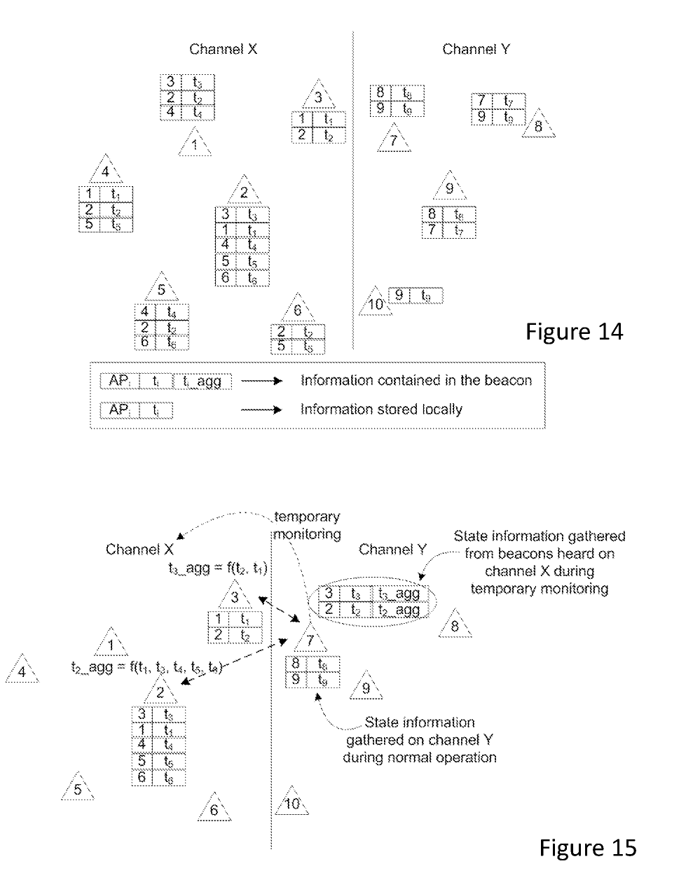

FIG. 14 shows the information stored on each of the access points shown in FIG. 13. The information may be gathered according to the method shown in FIG. 7. As shown in FIG. 14, the first AP 1 can receive beacons transmitted from the second AP 2, the third AP 3 and the fourth AP 4 and therefore stores indication of the traffic levels t₂, t₃, and t₄ on these APs. The second AP can receive beacons from each of the first

AP 1, the third AP 3, the fourth AP 4, the fifth AP5 and the sixth AP 6. Therefore the second AP 2 stores indications of the traffic levels t₁, t₃, t₄, t₅ and t₆ of these APs. The other APs operating on the first channel, channel X store indications of the traffic levels on the APs from which they can receive beacons.

The seventh AP 7 stores indications of the traffic levels on the eighth AP 8 and the ninth AP 9. Similarly, the other APs operating on the second channel, channel Y store indications of the traffic levels on the APs from which they can receive beacons. As shown in FIG. 14, because the indications of traffic level on other APs are gathered during normal operation, the indications of traffic level are only stored for APs operating on the same communication channel.

Further as shown in FIG. 14, each beacon includes an indication APᵢ of the AP from which it is transmitted, an indication of the traffic level t on that AP and an indication of the aggregate traffic level on the communication channel t_{i—}agg calculated by that AP.

FIG. 15 shows an example when the seventh AP 7 temporarily monitors the first channel, channel X, for example using the method shown in FIG. 11. As shown in FIG. 15, the seventh AP 7 can receive beacons transmitted from the second AP 2 and the third AP 3 when it is temporarily monitoring the first channel.

As shown in FIG. 15, the second AP 2 calculates an aggregate traffic level from the individual traffic levels on the first AP 1, the third AP3, the fourth AP 4, the fifth AP 5 and the sixth AP 6, and transmits a beacon including the calculated aggregate traffic level, and an indication of its traffic level t₂. The third AP 3 calculates an aggregate traffic level from the individual traffic levels on the first AP 1 and the second AP 2, and transmits a beacon including the calculated aggregate traffic level, and an indication of its traffic level t₃.

The seventh AP 7 stores state information from beacons received on channel X during temporary monitoring. This state information includes identifiers of the APs, the individual traffic levels on these APs and the aggregate traffic levels calculated by each of these APs. As shown in FIG. 15, the seventh AP 7 stores information gathered from beacons received on channel X from the first AP 1 and the second AP 2. The seventh AP 7 also stores state information gathered on channel Y (which is its communication channel) during normal operation. The information gathered from beacons on channel Y includes identifiers of the APs and the individual traffic levels on these APs.

As the example described above illustrates, an AP, in this case the seventh AP can quickly determine information about alternative operating channels from the aggregate traffic levels included in beacons transmitted by APs operating on those other channels.

An advantage of advertising the aggregate traffic state as heard by an AP, is that this can significantly reduce the information gathering time. Any AP that switches to a channel for monitoring and picks up beacons from certain APs is likely to see similar levels of potential interference to those APs. Therefore the AP need not wait to receive information from all possible APs around it but can quickly get a rough snapshot of the state of the channel by listening to a single beacon. This also means that the AP can quickly gather aggregate information in such a short time frame as beacons are sent on average every 100/500 ms depending on the frequency configured in the APs. Using this approach, an AP can build a picture of neighbouring channels and choose a channel which offers the potential for least interference.

In an embodiment, a variant of the proposed approach could employ aggregating the traffic state received from all neighbours instead of using the aggregate reported by each neighbour.

Additionally, to avoid synchronisation between neighbours, i.e. each neighbour acting at the same time, randomisation can be introduced. For example, instead of monitoring each channel sequentially, each AP could randomly select a channel such that it scans each of the available channels at least once per cycle. Moreover, randomisation can also be introduced during the channel switch process. For example, in a scenario where two or more neighbours are on the same channel, it is desirable if they don't act at the same time. That is, two APs switch channel at the same time to eventually land up on another channel which happens to be the same. To avoid such simultaneous switching, APs could randomise their decision when faced with a channel switch option, for example, pick a random number from a distribution and decide a course of action if this random number is less than some threshold.

The specific embodiments are presented schematically. The reader will appreciate that the detailed implementation of each embodiment can be achieved in a number of ways. For instance, a dedicated hardware implementation could be designed and built. On the other hand, a processor could be configured with a computer program, such as delivered either by way of a storage medium (e.g. a magnetic, optical or solid state memory based device) or by way of a computer receivable signal (e.g. a download of a full program or a “patch” update to an existing program) to implement the management unit described above in relation to the embodiments. Besides these two positions, a multi-function hardware device, such as a DSP, a FPGA or the like, could be configured by configuration instructions.

Whilst certain embodiments have been described, these embodiments have been presented by way of example only, and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1. A wireless communication method in an access point of a wireless network, the access point comprising at least one wireless interface operable to communicate on one of a plurality of channels, the method comprising
monitoring each of the plurality of channels, wherein monitoring a monitored channel from the plurality of channels comprises
switching the wireless interface to the monitored channel;
receiving a plurality of indications, each transmitted by a second access point on the monitored channel and indicating an aggregate traffic level calculated by the respective second access point; and
storing an indication of the highest aggregate traffic level received for the monitored channel;
comparing the stored highest aggregate traffic levels for the plurality of channels;
selecting as a communication channel, the channel from the plurality of channels having the smallest stored highest aggregate traffic level; and
communicating over the communication channel.

2. A method according to claim 1, wherein receiving a plurality indications comprises receiving a plurality of beacon frames and extracting an indication of an aggregate traffic level from each of the beacon frames.

3. A wireless communication method in an access point of a wireless network, the method comprising
receiving indications from other access points over a communication channel of the wireless network, the received indications each indicating a traffic level on the communication channel of a respective other access point;
calculating an aggregate traffic level from the received indications; and
transmitting an indication of the aggregate traffic level on the communication channel.

4. A method according to claim 3, wherein transmitting an indication of the aggregate traffic level on the communication channel comprises transmitting a beacon frame on the communication channel, the beacon frame comprising the indication of the aggregate traffic level.

5. A method according to claim 4, wherein the beacon frame further comprises an indication of the traffic level on the communication channel of the access point.

6. A method according to claim 3, wherein calculating the aggregate traffic level from the received indications comprises calculating the sum of the traffic levels on each of the other access points.

7. A non-transitory computer readable carrier medium carrying processor executable instructions which when executed on a processor cause the processor to carry out a method according to claim 1.

8. A non-transitory computer readable carrier medium carrying processor executable instructions which when executed on a processor cause the processor to carry out a method according to claim 3.

9. An access point for a wireless network comprising
a wireless network interface configured to receive indications on a communication channel from other access points, the received indications each indicating a traffic level on the communication channel of a respective other access point; and
a calculation module configured to calculate an aggregate traffic level from the received indications,
the wireless network interface being further configured to transmit an indication of the aggregate traffic level on the communication channel.

10. An access point according to claim 9, wherein the wireless network interface is configured to transmit a beacon frame on the communication channel, the beacon frame comprising the indication of the aggregate traffic level.

11. An access point according to claim 10, wherein the beacon frame further comprises an indication of the traffic level on the communication channel of the access point.

12. An access point according to claim 9, wherein the wireless network interface is configured to receive beacon frames transmitted by the other access points and the access point further comprises a monitoring module configured to extract the received indications from the beacon frames.

13. An access point for a wireless network comprising
a wireless interface operable to communicate on one of a plurality of channels,
a channel selection module configured to control the wireless network interface to receive signals on a monitored channel from the plurality of channels;
a monitoring module configured to monitor the monitored channel and extract indications, each transmitted by other access points on the monitored channel and indicating an aggregate traffic level calculated by the respective other access point;
a memory configured to store the highest aggregate traffic level received for each of a plurality of monitored channels; and
a calculation module configured to compare the stored highest aggregate traffic levels for the plurality of monitored channels,
wherein the channel selection module is configured to select as a communication channel, the channel from the plurality of channels having the smallest stored highest aggregate traffic level.

14. An access point according to claim 13, further comprising a communication module configured to control the wireless network interface to communicate on the communication channel.

15. An access point according to claim 13, further comprising a second wireless network interface and a communication module configured to control the second wireless network interface to communicate on the communication channel.

16. An access point according to claim 13, wherein the monitoring module is configured to extracting an indication of an aggregate traffic level from beacon frames transmitted by the respective other access points.
